(19) United States
(12) Patent Application Publication
(10) Pub. No.: US 2009/0095110 A1
(43) Pub. Date: Apr. 16, 2009

(54) ROTATIONAL MECHANISM WITH A CABLE-PROTECTING STRUCTURE

(75) Inventors: Chia-Peng Day, Santa Clara, CA (US); Jun-Hai Liu, Shenzhen City (CN); Xiao-Peng Pan, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/164,125

(22) Filed: Jun. 30, 2008

(30) Foreign Application Priority Data
Oct. 15, 2007 (CN) 200710202059.9

(51) Int. Cl. B25J 18/04

(52) U.S. Cl. 74/490.02

(57) ABSTRACT

An exemplary rotational mechanism (100) includes a cable (14), a cable-protecting structure (16), a first member (12) and a second member (10) rotatable relative to each other. The cable is fixed relative to the second member. A first through hole (128) is defined in the first member. The cable-protecting structure includes a bearing (161). The bearing includes an inside ring (163) and an outside ring (164) rotatable relative to each other. The bearing is received inside of the first through hole. The outside ring of the bearing is fixed to the first member. The cable is spaced from a ledge (1282) formed the first through hole and supported by the inside ring of the bearing.

### BACKGROUND OF THE INVENTION

1. Field of the Invention

The present invention relates to rotational mechanisms, and particularly, to a rotational mechanism with a cable-protecting structure.

2. Discussion of the Related Art

Cables are broadly used for transportation of electric power and signals in industry. A rotational mechanism for robotic arms having a cable usually includes a fixed arm and a rotary arm rotatably connected to the fixed arm. A motor is set inside the rotary arm. The cable extends through holes of the fixed arm and the rotary arm, and is connected to the motor. The cable, rotating together with the rotary arm, generally touches a ledge formed the hole defined in the fixed arm. Friction is generated between the ledge and the cable. As a result, the cable is easily damaged or abrased due to the friction, thus leading to electricity leakage and short circuit.

What is needed, therefore, is a rotational mechanism with a cable-protecting structure that can avoid the above-described problems.

### SUMMARY

An exemplary rotational mechanism includes a cable, a cable-protecting structure, a first member and a second member rotatable relative to each other. The cable is fixed relative to the second member. A first through hole is defined in the first member. The cable-protecting structure includes a bearing. The bearing includes an inside ring and an outside ring rotatable relative to each other. The bearing is received inside the first through hole. The outside ring of the bearing is fixed to the first member. The cable is spaced from a ledge formed the first through hole and supported by the inside ring of the bearing.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present rotational mechanism. Moreover, in the drawings, like reference numerals designate corresponding parts throughout several views, and all the views are schematic.

FIG. 1 is an exploded, isometric view of a rotational mechanism according to a preferred embodiment of the present invention.

FIG. 2 is an assembled, isometric view of the rotational mechanism shown in FIG. 1.

### DETAILED DESCRIPTION OF THE EMBODIMENT

Reference will now be made to the drawings to describe a preferred embodiment of the present rotational mechanism, in detail.

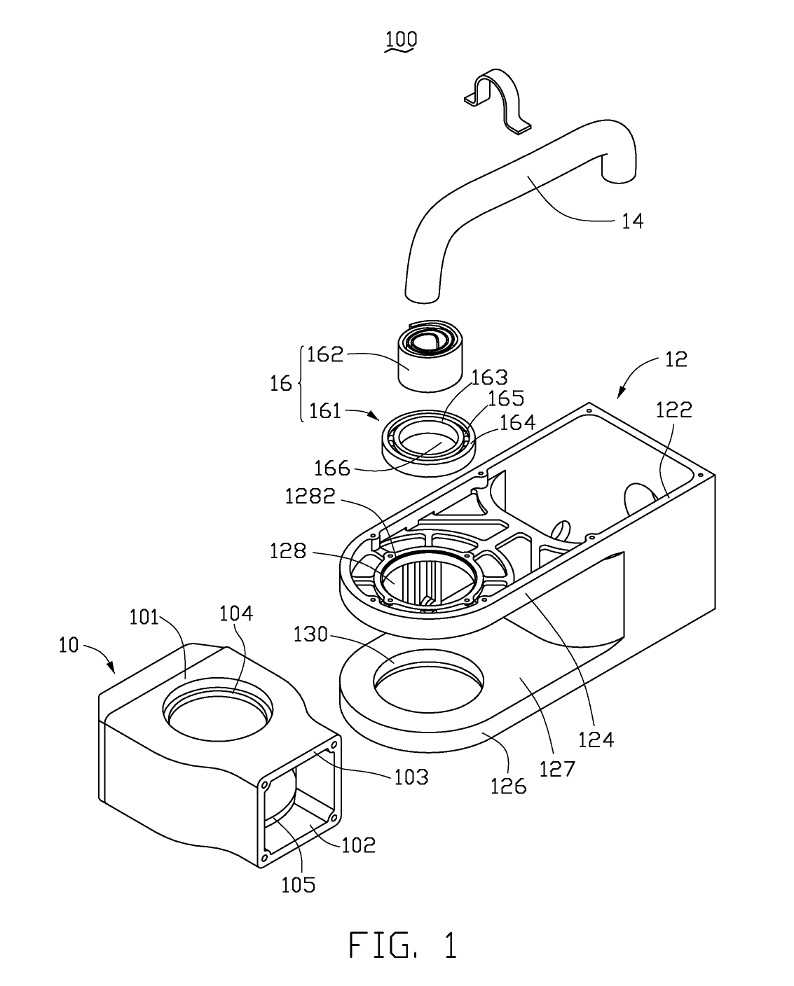

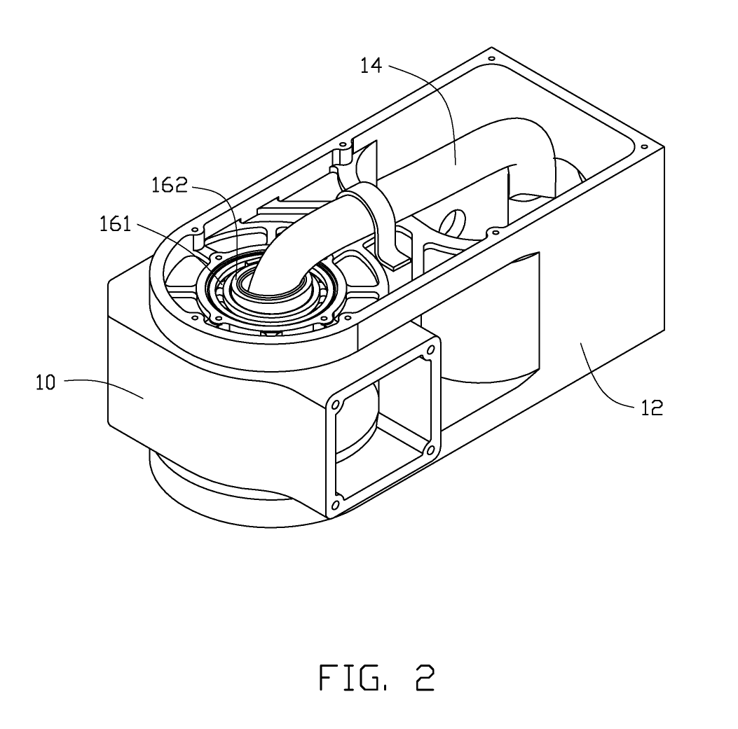

Referring to FIGS. 1 and 2, a rotational mechanism 100 in accordance with a preferred embodiment of the present invention is shown. The rotational mechanism 100 may be a joint in a first robotic/mechanical arm of a robotic/mechanical device. The rotational mechanism 100 includes a rotary arm 10, a support arm 12 connected to the rotary arm 10, a cable 14, and a cable-protecting structure 16.

The rotary arm 10 defines a cavity (not labeled). The rotary arm 10 includes a top plate 101, a bottom plate 102, and a connecting portion 103. A first receiving hole 104 is defined in a middle of the top plate 101. A second receiving hole 105 is defined in the bottom plate 102 corresponding to the first receiving hole 104. The connecting portion 103 is configured to be connected to a second robotic/mechanical arm (not shown). A first motor (not shown) is set inside the rotary arm 10 and fixed relative to the rotary arm 10, to be used to drive the second robotic/mechanical arm to rotate together.

The support arm 12 includes a main body 122 with two open ends. The support arm 12 also includes a first connecting plate 124 and a second connecting plate 126. The first and second connecting plates 124 and 126 extend from the open ends of the main body 122. The first and second connecting plates 124 and 126 are substantially symmetrically formed extending parallel toward a same side of the support arm 12. A receptacle 127 is defined between the first connecting plate 124 and the second connecting plate 126. The receptacle 127 is used for receiving the rotary arm 10. A first through hole 128 is defined in the first connecting plate 124. A second through hole 130 is defined in the second connecting plate 126 corresponding to the first through hole 128. A ledge 1282 is formed at an inner wall of the first through hole 128. The first through hole 128, the second through hole 130, the first receiving hole 104 and the second receiving hole 105 are circular holes with the same radius.

When assembled, axes of the first receiving hole 104, the first through hole 128, the second receiving hole 105 and the second through hole 130 are aligned on a same line, and the rotary arm 10 is aligned between the first connecting plate 124 and the second connecting plate 126. The first receiving hole 104 is adjacent to the first through hole 128, and the second receiving hole 105 is adjacent to the second through hole 130. The rotary arm 10 is connected to the support arm 12 by a certain connecting member (not shown). A second motor (not shown), set inside the main body 122, drives the rotary arm 10 to rotate relative to the support arm 12 around the axis of the first through hole 128.

The cable-protecting structure 16 includes a bearing 161. The bearing 161 includes an inside ring 163 defining a through hole 166, an outside ring 164, and a plurality of balls 165 disposed between the inside ring 163 and the outside ring 164. The bearing 161 is received inside the first through hole 128 abutting the ledge 1282 and is for preventing the cable 14 from touching the ledge 1282. The outside ring 164 of the bearing 161 is fixed to the first connecting plate 124. The inside ring 163, rotatable relative to the outside ring 164, can support the cable 14.

The cable-protecting structure 16 further includes a protective sleeve 162. The protective sleeve 162 is received in the through hole 166 of the inside ring 163. The cable 14 is inserted through the protective sleeve 162 and is connected to the first motor. Thus, the protective sleeve 162 is wrapped around the cable 14, preventing the cable 14 from touching the inside ring 163 of the bearing 161. In this embodiment, the protective sleeve 162 is made of polyethylene (PE) soft glue. Of course, the protective sleeve 162 can be made of other soft material with high wear resistance.

When the rotary arm 10 rotates relative to the support arm 12, the cable 14 and the protective sleeve 162 rotate with the inside ring 163 relative to the outside ring 164. Therefore, no friction is generated between the inside ring 163 and the protective sleeve 162. Additionally, the protective sleeve 162 protects the cable 14 from abrasing. Therefore, the cable 14 has a long service life. The cable-protecting structure 16 is able to protect the cable 14 efficiently.

Alternatively, the outside ring 164 of the bearing 161 and the support arm 12 may be integrally formed, for example, machining the outside ring 164 of the bearing 161 directly on the support arm 12.

Additionally, the cable-protecting structure 16 may be used in any other rotational mechanisms, besides the robotic/mechanical device, including devices having at least a first member and a second member rotatable relative to each other with the same manner as the support arm 12 and the rotary arm 10 in the embodiment.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A rotational mechanism for use with a cable, comprising:
a cable-protecting structure having a bearing including an inside ring and an outside ring rotatably connected to each other;
a first member which defines a first through hole, the bearing being received inside the first through hole, the outside ring of the bearing being fixed to the first member, and the cable being fixed relative to the second member, spaced from a ledge formed the first through hole, and supported by the inside ring of the bearing; and
a second member rotatably connected to the first member.

2. The rotational mechanism according to claim 1, wherein the second member defines a first receiving hole, and the first member is rotatable relative to the second member around an axis of the first through hole.

3. The rotational mechanism according to claim 1, wherein the cable-protecting structure includes a protective sleeve received inside the inside ring, and the cable is wrapped around by the protective sleeve.

4. The rotational mechanism according to claim 3, wherein the protective sleeve is made of soft material with high wear resistance.

5. The rotational mechanism according to claim 4, wherein the protective sleeve is made of polyethylene glue.

6. The rotational mechanism according to claim 1, wherein the outside ring of the bearing and the first member are integrally formed.

7. A mechanical arm device comprising:
a rotational mechanism for use with a cable, comprising:
a cable-protecting structure having a bearing including an inside ring and an outside ring rotatably connected to each other; and
a support arm which defines a first through hole, the bearing being received inside the first through hole, the outside ring of the bearing being fixed to the support arm, and the cable being fixed relative to the rotary arm, spaced from a ledge formed the first through hole, and supported by the inside ring of the bearing; and
a rotary arm rotatably connected to the support arm.

8. The mechanical arm device according to claim 7, wherein the rotary member defines a first receiving hole, and the support arm is rotatable relative to the rotary arm around an axis of the first through hole.

9. The mechanical arm device according to claim 7, wherein the cable-protecting structure includes a protective sleeve received in a through hole of the inside ring, and the cable is wrapped around by the protective sleeve.

10. The mechanical arm device according to claim 9, wherein the protective sleeve is made of soft material with high wear resistance.

11. The mechanical arm device according to claim 10, wherein the protective sleeve is made of polyethylene glue.

12. The mechanical arm device according to claim 7, wherein the outside ring of the bearing and the support arm are integrally formed.

13. A rotational mechanism for use with a cable, comprising:
a first member;
a second member rotatably connected to the first member; and
a cable-protecting structure disposed between the first and second members, the cable-protecting structure having a first part and a second part being rotatable relative to each other, the first part being fixed to the first member, and the cable being received in the second part.

14. The rotational mechanism according to claim 13, wherein the cable-protecting structure includes a protective sleeve, the protective sleeve is received in the second part, and the cable is wrapped around by the protective sleeve.
